(19) United States
(12) Patent Application Publication
(10) Pub. No.: US 2017/0208848 A1
(43) Pub. Date: Jul. 27, 2017

(54) PROCESS FOR MANUFACTURING AN IRON FORTIFIED FOOD PRODUCT

(71) Applicant: NESTEC S.A., Vevey (CH)

(72) Inventors: Sandrine Cavin, Epalinges (CH); Martin Michel, Lausanne (CH); Edwin Alberto Habeych Narvaez, Lausanne (CH)

(21) Appl. No.: 15/326,366

(22) PCT Filed: Jul. 9, 2015
(86) PCT No.: PCT/EP2015/065775

§ 371 Date: Jan. 13, 2017

(30) Foreign Application Priority Data
Jul. 15, 2014 (EP) 14177160.0

(51) Int. Cl. A23L 33/16; A21D 13/28; A23P 20/18; A21D 13/24

(52) U.S. Cl. CPC A23L 33/16; A21D 13/24; A21D 13/28; A23P 20/18; A23V 2002/00

(57) ABSTRACT

The present invention relates generally to fortified food products. In particular the invention relates to a process for manufacturing a food product fortified with iron. A further aspect of the invention is a food product obtainable by the process of the invention.

The present invention relates generally to fortified food products. In particular the invention relates to a process for manufacturing a food product fortified with iron. A further aspect of the invention is a food product obtainable by the process of the invention.

Billions of people around the world suffer from ‘hidden hunger’ or micronutrient malnutrition. They do not get enough of the micronutrients required to lead healthy productive lives from the foods that they eat. Micronutrients are nutrients required by humans and other organisms throughout life in small quantities to orchestrate a range of physiological functions. Micronutrients such as vitamins and dietary trace minerals are absolutely essential to good health. Micronutrient malnutrition can lower IQ, cause stunting and blindness in children, lower resistance to disease in both children and adults, and increase risks for both mothers and infants during childbirth. Iodine, vitamin A, zinc and iron are the most important micronutrients in global public health terms; their lack represents a major threat to the health and development of populations the world over, particularly children and pregnant women in low-income countries. Iron deficiency is a common and widespread nutritional disorder. As well as affecting a large number of children and women in developing countries it is also prevalent in industrialized countries. In wealthier countries people may voluntarily choose a diet which may cause a reduced iron intake, such as a vegetarian diet. Food fortification is one method to increase iron intake, along with dietary diversification and enhancement of iron absorption. For an effective food-fortification programme, the food carrier should be consumed in sufficient quantities and on numerous occasions making a significant contribution to the targeted population.

A number of problems are encountered when attempting to dose micronutrients such as iron into food. As relatively small quantities of iron need to be added, it is difficult to ensure an even distribution, for example when dosing iron into a viscous material such as biscuit dough. The iron may also interact with other components of the food, potentially leading to colour changes, off tastes and a reduction in the bioavailability of the iron.

WO2011/117012 describes applying nutrition-enhancing agents onto food products as droplets. However, micronutrients applied onto the surface of food products often have a high exposure to air and light and so may be easily become degraded, for example by oxidation. Ink compositions containing micronutrients have been described in WO2007/115050 for use with comestible products, but the application of iron is not disclosed and there is no indication of how to stabilize the micronutrients in the ink.

There is a need to provide a process for manufacturing a food product fortified with iron where the iron is stabilized, for example by being protected against oxidation during shelf-life. Such a process should ideally allow precise dosage of the micronutrients and not lead to significant losses of bioavailable iron during processing.

An object of the present invention is to improve the state of the art and to provide a solution to address at least some of the needs described above, or at least to provide a useful alternative. Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The object of the present invention is achieved by the subject matter of the independent claims. The dependent claims further develop the idea of the present invention.

### SUMMARY OF THE INVENTION

The present invention provides in a first aspect a process for manufacturing a food product fortified with iron, the process comprising
providing a liquid composition comprising at least 0.25 wt. % iron, at least 5 wt. % saccharides having between 1 and 9 monosaccharide units, and water; and
spraying the liquid composition onto an edible material.

In a second aspect, the invention relates to a food product obtainable by the process of the invention.

It has been surprisingly found by the inventors that when iron is sprayed onto an edible material, the presence of saccharides stabilizes the iron. For example the saccharides may protect the iron from oxidation and reduce or prevent colour change.

### BRIEF DESCRIPTION OF THE DRAWINGS

FIG. 1 shows images of pre-printed biscuits to which iron was applied via an ink-jet printer in three different aqueous liquid compositions and the biscuits stored at aw=0.22, 0.43 and 0.64 for 4 weeks. A drop of ferrozine has been added to indicate the presence of Fe(II), indicated by an arrow. Composition A: propylene glycol, composition B: glucose, and composition C: sucrose/fructose

FIG. 2 shows images of pre-printed biscuits to which iron was applied in two different aqueous liquid compositions, storage at aw=0.33 and 0.64 for 4 weeks. Composition D: no sucrose and E: sucrose.

FIG. 3 shows images of biscuits to which iron was applied via an ink-jet printer in four different aqueous liquid compositions, storage at aw=0.43 under daylight irradiation for 72 hours. Composition F: sucrose, composition G: sucrose/tri-sodium citrate, composition H: sucrose/tri-sodium citrate/acacia gum and composition I: sucrose/tri-sodium citrate/propylene glycol.

### DETAILED DESCRIPTION OF THE INVENTION

Consequently the present invention relates in part a process for manufacturing a food product fortified with iron, the process comprising
providing a liquid composition comprising at least 0.25 wt. % iron, at least 5 wt. % saccharides having between 1 and 9 monosaccharide units, and water; and
spraying the liquid composition onto an edible material.

In the current invention the term “food product fortified with iron” refers to a food product where the content of iron has been increased, for example to improve its nutritional quality. The iron may, or may not, have been originally in the food.

The liquid composition in the process of the invention may comprise at least 0.25 wt. % iron, calculated on the basis of elemental iron. For example the liquid composition may comprise at least 1 wt. % iron, for further example the liquid composition may comprise at least 2.5 wt. % iron.

The liquid composition in the process of the invention may comprise at least 5 wt. %, for example at least 10 wt. %, of saccharides having between 1 and 9 monosaccharide units. The saccharides may be selected from the group consisting of monosaccharides, disaccharides, oligosaccharides (3-9 monosaccharide units), and combinations of these. For example the saccharides may be selected from the group consisting of fructose; glucose; sucrose; maltose; lactose; invert syrup (comprising fructose and glucose); honey (comprising fructose and glucose); maple syrup (comprising sucrose); fructo-oligosaccharides, high DE (dextrose equivalent) hydrolyzed starch syrups and combinations of these. The quantity of water used in the liquid composition may be readily determined by the skilled person so as to fully dissolve or disperse the ingredients, provide a suitable viscosity for spraying and avoid very high water activities in which would be difficult to maintain microbiological safety. The liquid composition in the process of the invention may contain between 45 wt. % and 65 wt. % water.

Ethanol is sometimes used as a solvent in liquid compositions intended to be sprayed as the ethanol kills bacteria giving the liquid composition a long storage life, and it dries quickly on the substrate. It may also function as a surface tension modifier. However applying liquid compositions with a high levels of ethanol to edible materials can have a number of disadvantages. Ethanol is flammable, presenting a safety risk, it can impart a bitter taste when incorporated in edible materials and some colourants precipitate in the presence of ethanol. Certain religious dietary laws forbid the consumption of ethanol. The process of the current invention advantageously may use a water-based liquid composition; that is a composition where the solvent is predominantly water. The process of the invention may use a liquid composition which contains less than 0.5 wt. % ethanol, for example less than 0.01 wt. % ethanol, for further example, no ethanol.

Ethanol is not the only monohydric alcohol which may be encountered in edible materials; isopropyl alcohol (propan-2-ol) is sometimes used in liquid compositions as a solvent and surface tension modifier. Isopropyl alcohol is not considered by consumers to be a familiar ingredient in edible materials and has many of the same disadvantages as ethanol, so it is an advantage to be able to formulate an liquid composition without it. Fortunately, the process of the current invention may spray a liquid composition comprising iron without the use of isopropyl alcohol. The liquid composition of the process of the invention may be free from monohydric alcohols. Monohydric alcohols are alcohols with only one hydroxyl group.

In the context of the current invention, spraying the liquid composition refers to sending the liquid composition through the air in drops and includes processes such as ink-jetting. The quantity of liquid composition sprayed onto the edible material may be sufficient to provide at least 0.8 mg iron per 100 g of food product. The edible material may be a solid. In the present invention a solid material is one which is firm and stable in shape.

The form of iron forms that are commonly used in food fortification are ferrous (iron(II)) and ferric (iron(III)). Both of these readily form complexes with electron-rich components yielding species that influence taste and bioavailability. Also, iron has the ability to undergo oxidation-reduction (redox) reactions that cause many of the unwanted outcomes related to taste, appearance, and bioavailability. The iron in the liquid composition used in the process of the invention may be in the form of iron (III), for example it may be provided as sodium iron (III) ethylenediaminetetraacetate (NaFeEDTA) or ferrichrysin. The iron in the liquid composition used in the process of the invention may be in the form of iron(II), for example it may be provided as a material selected from the group consisting of ferrous sulphate, ferrous citrate, ferrous fumarate, ferrous picolinate, ferrous bisglycinate, ferrous carbonate, ferrous gluconate, ferrous lactate, ferrous L-pidolate, ferrous phosphate, ferrous taurate, and ferrous ammonium phosphate. Preferably it may be provided as ferrous sulphate. The World Health Organization (WHO) recommended that ferrous sulphate should be the first choice among iron fortificants because of its high bioavailability [Guidelines on food fortification with micronutrients. World Health Organization, 2006]. At low pH, iron(II) is relatively stable, but the higher pH values common in food, iron(II) rapidly oxidizes to iron(III) and, in time, becomes rust. The brown colour of rust is unattractive on a food product. It is therefore particularly beneficial that the process of the invention can provide a food product fortified with iron(II) where the iron is stable against oxidation. The iron comprised in the liquid composition of the process of the invention may be in solution. Soluble iron generally has improved bioavailability and solid particles of iron may lead to blockages in the spraying apparatus.

An important method of controlling food hygiene risks is to heat-treat components which may harbour food pathogens or spoilage organisms. A well-known example of such a heat treatment is pasteurization, for example heating a food material to 72° C. for 15 seconds. The process of the invention may further comprise heat treating the liquid composition, for example heating the liquid composition to above 70° C. for at least 10 seconds, for example at least 1 minute, for further example at least 5 minutes. The presence of saccharides in the liquid composition helps prevent the iron becoming oxidized during this process and forming a precipitate. For example, when a liquid composition comprising fructose and iron(II) was heated for 35 minutes at 75° C. the solution remained transparent with no precipitation. Precipitation would not only remove iron from the liquid composition and hence reduces the iron level in the liquid composition sprayed onto the edible material, but also might lead to blockages of the spraying nozzles.

Over the shelf-life of the food product, the saccharides in the liquid composition may begin to caramelize. This can lead to a darkening of the regions of the food product where the liquid composition has been applied. It is advantageous if the saccharides comprised within the liquid composition of the process of the invention are selected so that they do not readily caramelize, for example that they have a caramelization temperature above 120° C. The saccharides comprised within the liquid composition in the process of the invention may be selected from the group consisting of sucrose, glucose, maltose, lactose and combinations of these. The saccharides may be sucrose.

The liquid composition in the process of the invention may further comprise at least 0.5 wt. % polysaccharide. Polysaccharides are polymeric carbohydrate molecules composed of long chains of monosaccharide units bound together by glycosidic linkages. In the scope of the present invention, a polysaccharide has 10 or more monosaccharide units. The inventors found that by including polysaccharides in the liquid composition the stability of the iron in the fortified food product could be increased. Without wishing to be bound by theory, it is believed that the saccharides are in an amorphous phase when sprayed onto the edible material, and this encloses and stabilizes the iron, being kinetically stable. By adding polysaccharides to the liquid composition, the glass transition temperature is increased, increasing the stability in the presence of ambient humidity. Furthermore, the polysaccharides may form a protective film encasing the iron.

The polysaccharide comprised in the liquid composition of the process of the invention may be selected from the group consisting of maltodextrin, acacia gum, agar-agar, carrageenan, tragacanth, locust bean gum, guar gum, xanthan gum and combinations of these. Carrageenan and acacia gum were found to be particularly effective at preventing or delaying browning of the sprayed regions of the edible material when included in the liquid composition according to the process of the present invention, for example browning due to oxidation of iron. The polysaccharide may be carrageenan or acacia gum.

The liquid composition in the process of the invention may further comprise at least 1 wt. % of an edible sugar alcohol or diol, for example at least 2 wt. % of an edible sugar alcohol or diol, for further example at least 4 wt. % of an edible sugar alcohol or diol. The edible sugar alcohol or diol may be selected from the group consisting of propylene glycol, sorbitol, glycerol, xylitol and combinations of these. The inventors found that, by including an edible sugar alcohol or diol in the liquid composition, the stability of the iron in the fortified food product could be increased. The edible sugar alcohol or diol may also have the effect of lowering the surface tension of the liquid composition and making it easier to spray. Xylitol is particularly beneficial as it may suppress any metallic taste coming from the iron.

The liquid composition in the process of the invention may further comprise a buffer. In the present invention, the term buffer includes any material added to control pH, not just a classical buffer of a mixture of a weak acid and its conjugate base, or vice versa. The buffer may be a citrate or phosphate salt. The buffer may be tri-sodium citrate or tri-potassium citrate. The buffer may be present in the liquid composition at a level of at least 0.5 wt. %. Buffers in the liquid composition such as tri-sodium citrate or tri-potassium citrate delay the oxidation of iron, both before spraying (preventing precipitation of iron during any heat treatment) and during the shelf-life of the food product manufactured according to the process of the invention. Buffers such as tri-sodium citrate or tri-potassium citrate may also slow down any caramelization of the saccharides. The liquid composition may comprise at least 0.25 wt. % iron, at least 10 wt. % sucrose, at least 0.5 wt. % tri-sodium citrate, and water. The liquid composition may comprise at least 0.25 wt. % iron, at least 10 wt. % sucrose, at least 0.5 wt. % tri-sodium citrate, at least 4 wt. % propylene glycol, and water. The liquid composition may comprise at least 0.25 wt. % iron, at least 10 wt. % sucrose, at least 0.5 wt. % tri-sodium citrate, at least 4 wt. % propylene glycol, at least 0.5 wt. % acacia gum, and water.

The liquid composition may be sprayed onto a food substance during food item preparation, for example the edible material of the process of the invention may be unbaked biscuit dough. The edible material of the process of the invention may be a food substance in a cooked or partially cooked state. Preferably, the liquid composition should be sprayed onto the food substance after any preparation steps which might accelerate the oxidation of the iron, for example the liquid composition may be sprayed onto a biscuit after baking.

The food product manufactured by the process of the invention may be a confectionery product, ice cream, prepared meal item, bouillon cube, breakfast cereal or pet food. The term confectionery product includes for example biscuits, such as filled biscuits, printed biscuits, iced biscuits or wafer biscuits; fat based confectionery, such as chocolate; and sugar confectionery, such as sugar panned confectionery, pressed tablets or high-boiled sweets. Breakfast cereal is a food made from processed grains that is often eaten as the first meal of the day. Breakfast cereals include ready to eat breakfast cereals as well as cereal grains or flakes which are prepared and served warm as porridges. Bouillon cubes are concentrated bouillon or stock which is provided in a compressed form, traditionally in the shape of a cube. Fortifying bouillon cubes with iron is particularly problematic as the iron may interact with ingredients in the bouillon and cause colour changes. The process of the invention can provide a bouillon cube with stabilized iron applied onto its surface and so prevent or reduce the interactions which cause undesirable colour change.

The food product manufactured by the process of the invention may be a confectionery product, ice cream or bouillon cube.

The food product may be light coloured. It is particularly beneficial that the process of the invention allows applying iron on the surface of light coloured food products without leading to unsightly colour change during the shelf-life of the product. The bouillon cube manufactured by the process of the invention may be light coloured, for example a chicken, fish or vegetable stock cube. The confectionery product manufactured by the process of the invention may be a biscuit. Biscuits are good carriers for food fortificants due to their long shelf-life and convenience, with no need of preparation by the consumer.

The liquid composition in the process of the invention may be sprayed onto the edible material using an ink-jet printer. Ink-jet printing technology is a reliable, quick and convenient method of printing on a variety of surfaces. An ink-jet printer allows a precise application of the liquid composition on a specific region of the edible material. Although ink-jet printers conventionally apply an ink which contains a pigment, in the scope of the present invention it should be understood that the ink-jet printer may apply the liquid composition with or without a pigment. The inkjet printer in the process of the current invention may be any of the devices known in the art. For example, the inkjet printer may be a drop-on-demand system or a continuous inkjet system. The inkjet printer may be a piezo drop-on-demand system.

The liquid composition sprayed onto the edible material in the process of the invention may further comprise a pigment. It may be convenient to add a decoration such as a colour to the surface of a food product at the same time as applying iron. In the case where the liquid composition is sprayed using an ink-jet printer, by including a pigment, a design can be applied to the food product in the same process step as the iron fortification. Such a design may be used to indicate to the consumer that the food product has been fortified.

Some micronutrients are not stable in the presence of iron. Although iodine, vitamin A and iron are important micronutrients it is not straightforward to provide fortified foods with stable combinations of these. Iodine, iron and vitamin A interact with each other leading to their depletion. For example iodine, present as iodide or iodate, is oxidized to free iodine in the presence of ferrous ions and oxygen. It is an advantage of the process of the invention that other micronutrients may be stabilized in the presence of iron. The liquid composition sprayed onto the edible material in the process of the invention may further comprise micronutrients in addition to iron. The micronutrients may be selected from the group consisting of cobalt, chromium, copper, iodine, manganese, selenium, zinc, molybdenum, vitamin A, vitamin B₁, vitamin B₂, vitamin B₃, vitamin B₅, vitamin B₆, vitamin B₇, vitamin B₉, vitamin B₁₂, vitamin C, vitamin D, vitamin E, vitamin K and combinations of these. For example, the liquid composition of the process of the invention may further comprise vitamin A and/or iodine.

Another option for combining micronutrients with iron which tend to be unstable in combination is to spray a liquid composition containing iron onto one region of the edible material, and spray a second liquid composition containing another micronutrient onto a different region of the edible material. This may be used to provide a food product fortified with iron and another micronutrient with even greater stability. For example, when ink-jet printers are used which provide accurate placement of the droplets, the two liquid compositions may be applied as tightly interlaced patterns. In the process of the invention, a further liquid composition which comprises a micronutrient but does not contain iron may be sprayed onto regions of the edible material which were not sprayed by the first liquid composition. The further liquid composition may comprise iodine and/or vitamin A.

The liquid composition sprayed in the process of the invention may be unevenly applied to the edible material, for example it may be sprayed onto one region of the edible material. For example, where the edible material is in the form of individual pieces, the liquid composition may be sprayed onto one region of each individual piece. As well as the advantage of improved stability of combinations of micronutrients with iron described above, applying a liquid composition comprising iron to a specific area of a food product can avoid contact with other components which might be oxidized or change colour in the presence of iron. For example, chromophores compounds naturally occurring in fruit may change colour in the presence of iron. This can cause undesirable effects on fruit containing products such as fruit-filled biscuits. It is therefore advantageous to spray the liquid composition comprising iron on a part of the biscuit where the fruit filling will not be applied.

The invention may provide a fortified food product with stabilized iron present on the surface of the product, the iron being encased in a protective carrier created by the process steps of the invention. The present invention may be a food product obtainable, for example obtained, by the process of the invention.

Those skilled in the art will understand that they can freely combine all features of the present invention disclosed herein. In particular, features described for the process of the present invention may be combined with the product of the present invention and vice versa. Further, features described for different embodiments of the present invention may be combined. Where known equivalents exist to specific features, such equivalents are incorporated as if specifically referred to in this specification. Further advantages and features of the present invention are apparent from the figures and non-limiting examples.

### Examples

### Example 1: Comparison of Protective Effects of Different Liquid Compositions on Fe(II)

A comparison was made between the stability of iron(II) in sprayed in three different aqueous liquid compositions. Liquid composition A contained propylene glycol (a material commonly used in ink-jet inks), liquid composition B glucose, and liquid composition C a mixture of sucrose and fructose. The liquid compositions were prepared as follows.

Liquid composition A: In a 3.0 mL volumetric flask, 1.55 g of ferrous sulfate heptahydrate (Paul Lohmann, Germany) and 5 mL of propylene glycol (Fluka, Germany) were added and filled up to the gauge with miliQ water. Finally, a drop of Tween 80 (Serva, Germany) was added.

Liquid composition B: In a 10 mL volumetric flask, 1.55 g of ferrous sulfate heptahydrate (Paul Lohmann, Germany) and 3 g of D-glucose monohydrate (Merck, Germany) were added and filled up to the gauge with miliQ water. Finally, a drop of Tween 80 (Serva, Germany) was added.

Liquid composition C: In a 10 mL volumetric flask, 1.55 g of ferrous sulfate heptahydrate (Paul Lohmann, Germany), 2.27 g of fructose (Fluka, Israel) and 3.92 g of sucrose (Merck, Germany) were added and filled up to the jauge with miliQ water. Finally, a drop of Tween 80 (Serva, Germany) was added.

The three different liquid compositions were filtered through a 0.2 μm filter Chromafil® PET-20/25 (Macherey-Nagel GmbH & Co. KG, Germany) and immediately filled into printing cartridges DMC-11610 (FUJIfILM Dimatix, USA). The cartridges were placed in an ultrasonic bath for 30 minutes in order to remove any dissolved gas, before being allowed to stand, with the nozzles facing down, for 30 minutes before use.

Passatempo™ biscuits with a design already printed on them were overprinted at 400 dpi with the three liquid compositions A, B and C using a DMP-2831 inkjet printing system (FujiFilm Dimatix, USA). A square area roughly covering the top surface of each biscuit was printed using the standard waveform suggested by Dimatix and a jetting frequency of 5 KHz. Temperature and voltage were adapted for each solution to print around 5 mg of fluid over their surfaces.

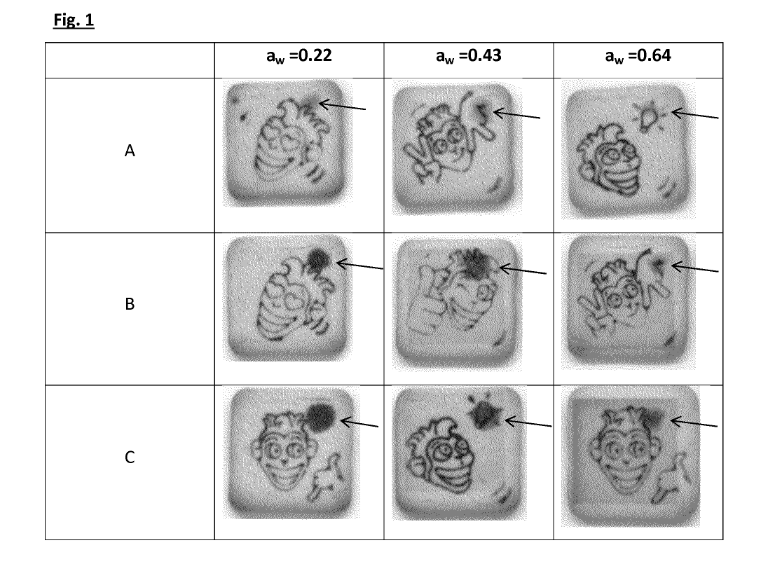

The printed biscuits were stored for 5 weeks under different water activities in desiccators with saturated salt solutions providing a_{w}=0.22, 0.43 and 0.64. The presence of Fe(II) was detected using ferrozine solution. Into a 50 mL volumetric flask, about 25 mg of ferrozine was weighed to the nearest 0.1 mg and made up to the volume with acetate buffer (pH 4.3). A drop of this ferrozine solution was placed on each printed biscuit. The colour changes instantly to pink/violet in presence of Fe(II) ions. The results are shown in FIG. 1, reproduced in black and white. The location of the drop of ferrozine is indicated with an arrow.

To obtain the images in FIG. 1, Passatempo™ biscuits were placed in the middle of the illumination cabinet of the digital colour imaging system (DigiEye, Verivide, England) on a white carton plate. Samples were illuminated by a diffuse D65 light source and images captured by a calibrated camera.

It can be seen that liquid compositions containing saccharides (B and C) prevent the loss of Fe(II) much better than the liquid composition containing no saccharides (A). Storage at a_{w}=0.64 led to an almost complete loss of Fe(II) with liquid composition A.

### Example 2: Effects of Sucrose on Browning

Liquid compositions were prepared with and without sucrose. The liquid composition with sucrose (liquid composition E) was prepared by mixing 1.15 wt. % tri-sodium citrate dihydrate (Merck, Germany), 30 wt. % sucrose (Merck, Germany) and 52.85 wt. % MiliQ water until complete dissolution. Then 16 wt. % iron sulphate heptahydrate (Paul Lohmann) was added to the liquid composition and the liquid composition was pasteurized at 75° C. for 35 minutes. Liquid composition D was made up the same way except that the sucrose was omitted and 82.85 wt. % water was used.

Each liquid composition was placed in the syringe of a syringe pump (Harvard PHD 2000 N^{o} 3) and sprayed onto Passatempo™ biscuits (already printed with a design) at a pressure of 4 bar to apply 20-25 mg of fluid. Half the Passatempo™ biscuits were placed in a desiccator at a water activity of 0.33 and half at a water activity of 0.64. The biscuits were stored for a month at 23° C. and calibrated pictures were taken at time=0, 1 week, 2 weeks and 4 weeks. The results (FIG. 2) show that browning of the biscuits increases with water activity of storage, but the presence of sucrose in the liquid composition reduced the browning considerably.

### Example 2: Effect of Polysaccharides and Buffers on Browning

Four liquid compositions were prepared as below.

| Ingredient (% by weight) | F | G | H | I |
|---|---|---|---|---|
| Iron sulphate heptahydrate | 16.00 | 16.00 | 16.00 | 16.00 |
| (Dr Paul Lohmann, Germany) | | | | |
| Tri-sodium citrate dehydrate | — | 1.15 | 1.15 | 1.15 |
| (Merck, Germany) | | | | |
| Acacia Gum | — | — | 7.00 | — |
| (CNI, France) | | | | |
| Sucrose | 30.00 | 30.00 | 23.00 | 35.00 |
| (Merck, Germany) | | | | |
| Propylene glycol | — | — | — | 5.00 |
| (Fluka, Germany) | | | | |
| MiliQ water | 54.00 | 52.85 | 52.85 | 42.87 |

The powders were mixed before adding water (and propylene glycol for I), then the solutions were stirred for 10 minutes at room temperature before being pasteurized at 75° C. for 35 minutes. 100 μl of an emulsion of 10% CITREM in water was added to each of these liquid compositions prior to spraying using an ink-jet printer. The CITREM reduces the fluid surface tension. The different liquid compositions were filtered through a 0.2 μm filter Chromafil® PET-20/25 (Macherey-Nagel GmbH & Co. KG, Germany) and immediately filled into printing cartridges DMC-11610 (Dimatix, USA). The cartridges were placed in an ultrasonic bath for 30 minutes in order to remove any dissolved gas, before being allowed to stand, with the nozzles facing down, for 30 minutes before use.

10 biscuits were printed with each of these liquid compositions at 400 dpi using a DMP-2831 inkjet printing system (FujiFilm Dimatix, USA) over the unprinted surface of Passatempo™ biscuits. The standard waveform suggested by Dimatix and jetting frequency of 5 KHz was used. The voltage and temperature were adjusted to spray around 5 mg of fluid onto the biscuit surface.

Two biscuits of each composition were stored in a desiccator at an a_{w}=0.43 and placed under controlled daylight irradiation using the Suntest® Atlas XLS with Suncool option (Atlas Material Technology Gmbh, Switzerland) with the following parameters:
Irradiation: 60 W/m
T_{Chamber}=18° C.
Black Standard Temperature: 25° C.

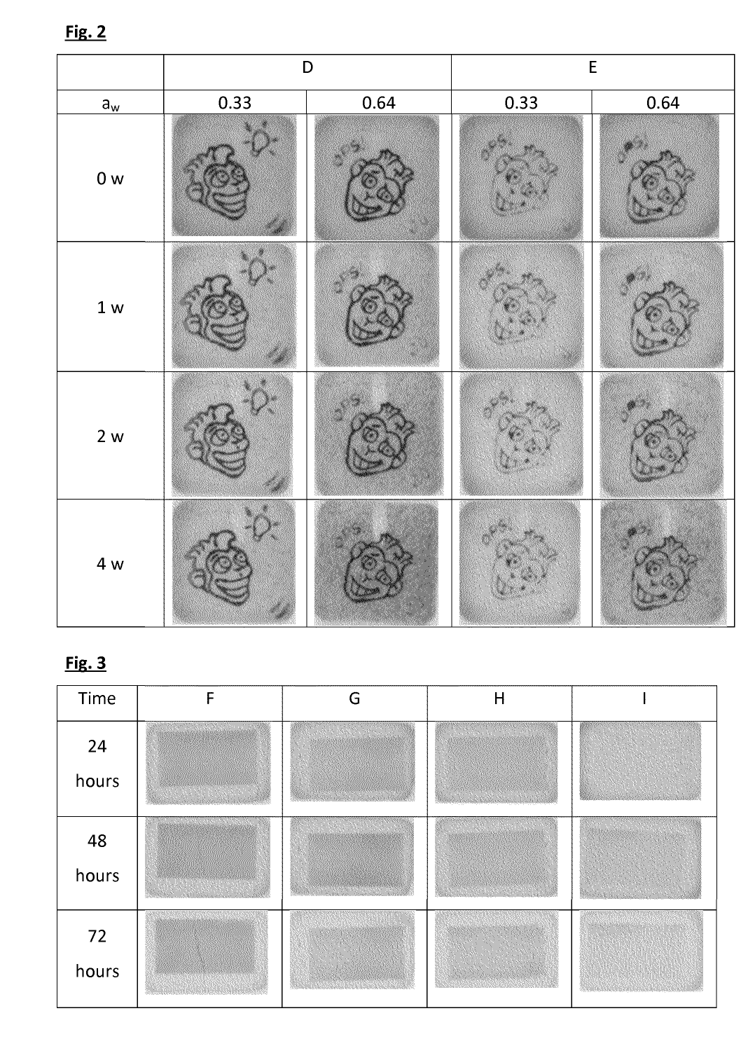

Calibrated photographs were taken after 24 hours, 48 hours and 72 hours (see FIG. 3). The addition of a buffer (tri-sodium citrate) in composition G reduced the browning compared to sucrose alone (solution F). The addition of a polysaccharide (acacia gum) in composition H reduced the browning still further. Although propylene glycol alone was not effective at protecting iron (liquid composition A) it can be seen that when combined with sucrose (liquid composition I) it delays discolouration.

1. Process for manufacturing a food product fortified with iron comprising:
providing a liquid composition comprising at least 0.25 wt. % iron, at least 5 wt. % saccharides having between 1 and 9 monosaccharide units and water; and
spraying the liquid composition onto an edible material.

2. A process according to claim 1 wherein the iron is in the form of iron(II).

3. A process according to claim 1 wherein the saccharides are selected from the group consisting of sucrose, glucose, maltose, lactose and combinations of these.

4. A process according to claim 1 wherein the liquid composition comprises at least 0.5 wt. % polysaccharide.

5. A process according to claim 4 wherein the polysaccharide is selected from the group consisting of maltodextrin, acacia gum, agar-agar, carrageenan, tragacanth, locust bean gum, guar gum, xanthan gum and combinations of these.

6. A process according to claim 1 wherein the liquid composition comprises at least 1 wt. % of an edible sugar alcohol or diol.

7. A process according to claim 6 wherein the edible sugar alcohol or diol is selected from the group consisting of propylene glycol, sorbitol, glycerol, xylitol and combinations of these.

8. A process according to claim 1 wherein the liquid composition comprises a buffer.

9. A process according to claim 1 wherein the liquid composition comprises vitamin A and/or iodine.

10. A process according to claim 1 wherein the food product is selected from the group consisting of a confectionery product, ice cream, prepared meal item, bouillon cube, breakfast cereal and pet food.

11. A process according to claim 10 wherein the confectionery product is a biscuit.

12. A process according to claim 1 wherein the liquid composition is sprayed onto the edible material using an ink-jet printer.

13. A process according to claim 1 wherein the liquid composition comprises a pigment.

14. A process according to claim 1 wherein a further liquid composition which comprises a micronutrient but does not contain iron is sprayed onto regions of the edible material which were not sprayed by the first liquid composition.

15. A food product obtained by manufacturing a food product fortified with iron using the steps comprising:
providing a liquid composition comprising at least 0.25 wt. % iron, at least 5 wt. % saccharides having between 1 and 9 monosaccharide units and water; and
spraying the liquid composition onto an edible material.
